(19) United States
(12) Patent Application Publication
(10) Pub. No.: US 2016/0001970 A1
(43) Pub. Date: Jan. 7, 2016

(54) Packs for Preparing Beverages

(71) Applicant: NESTEC S.A., Vevey (CH)

(72) Inventors: Thomas Kaeser, Brent (CH); Silvio BUTSCHER, Chezard-St-Martin (CH); Pierre STRUZKA, La Chaux-De-Fonds (CH); Jean-Luc DENISART, Cully (CH); Damien NEUROHR, Sion (CH); Yves MARMIER, La Chauxi-de-Fonds (CH); Sébastien DASSI, St-Blaise (CH); Cynthia SCHERZ, Allaman (CH); Fabien CHIAPPINI, Petit Lancy (CH); Martin MÜLLER, Horw (CH); Christoph CZARNETZKI, Finnentrop (DE); Frank RÖMER, Finnentrop (DE)

(21) Appl. No.: 14/768,609

(22) PCT Filed: Feb. 18, 2014
(86) PCT No.: PCT/EP2014/053134

§ 371 Date: Aug. 18, 2015

(30) Foreign Application Priority Data
Feb. 18, 2013 (EP) 13155631.8
Feb. 18, 2013 (EP) 13155634.2
Jul. 23, 2013 (EP) 13177535.5

(51) Int. Cl. B65D 85/804; B65B 43/02; B65B 29/02; A23L 2/395; A47J 31/40

(52) U.S. Cl. CPC B65D 85/8046; A23L 2/395; A47J 31/407; B65B 29/02; B65B 43/02

(57) ABSTRACT

A pack in which a food or beverage ingredient is stored and in which a beverage is produced when water is introduced inside is disclosed, along with methods of production and use thereof.

### CROSS REFERENCE TO RELATED APPLICATIONS/INCORPORATION BY REFERENCE STATEMENT

This application is a US national stage application filed under 35 USC §371 of International Application No. PCT/EP2014/053134, filed Feb. 18, 2014; which claims benefit of EP Application No. 13155631.8, filed Feb. 18, 2013; EP Application No. 13155634.2, filed Feb. 18, 2013; and EP Application No. 13177535.5, filed Jul. 23, 2015. The entire contents of the above-referenced applications are hereby expressly incorporated herein by reference.

### BACKGROUND

The presently disclosed and/or claimed inventive concept(s) relates to packs and methods for the preparation of foods or beverages from packs comprising a food or beverage ingredient.

It is known to prepare beverages by introducing a capsule containing a beverage making ingredient, such as ground coffee or instant coffee, in a beverage dispensing machine and injecting water into the capsule. The beverage making ingredient is extracted or dissolved into water to form the beverage. The beverage flows out of the capsule through a suitable outlet.

Different capsules have been developed in the past that can differentiate at least by the nature of the capsule body used for storing the food or beverage ingredient. Whereas most of the capsules are made of a rigid body or semi-rigid body (e.g. made though injection moulding, thermoforming, deep drawing, . . . ) flexible types of packs or sachets can be made out of foil materials. Flexible packs have generally the advantage to semi-rigid and rigid capsules that less amount of material is used to pack the product which leads to overall less production cost and lower life cycle impact shown in several life-cycle assessments.

WO 99/05044, GB 2 374 856 and WO 2012/175985 describe such a flexible pack made of two sheets of flexible air-and liquid-impermeable material bonded on theirs edges to define an inner volume for storing the beverage ingredient. The pack comprises an inlet nozzle at its top for introducing water that is mixed with the beverage ingredient inside the inner volume. The beverage is evacuated through a beverage outlet at the bottom of the sachet. The outlet is created further to bursting of the pack under the pressure of water introduced in the sachet. Generally the outlet is created due to the separation of the bottom edges of the flexible sheets further to the effect of heat or pressure in the sachet. According to a particular embodiment a spout can be introduced at the bottom of the pack: in that embodiment, the bottom edges of the flexible sheets do not separate and the beverage is evacuated by the spout.

These flexible sachets present drawbacks. Generally the opening of the beverage outlet is obtained by increase of pressure inside the sachet. Yet this pressure increase is not recommended for the preparation of some beverages because it creates bubbles at the surface of the beverage; for example it is not desired for the preparation of tea. Besides there can be a risk that the packages may not rupture at the desired pressure and that it can finally open up in an uncontrollable explosion. For this reason the apparatus comprises means for totally enclosing the pack in the machine during beverage preparation and avoid damages or injuries for the operator.

Another drawback of these sachets is that the inlet spout introduces water in the pack always according to the same vertical top-down orientation in the sachet. Then all the beverages are produced according to the same process inside the sachet. Yet depending on the nature of the beverage ingredient and the desired beverage the beverage ingredient should be processed differently depending e.g. if foam is desired or not. In WO2012175985 a solution has been proposed which consists in proposing a beverage machine with different brewing heads (clamp) either for high pressure or low pressure beverage preparation.

Another drawback of these sachets is that it does not enable the delivery of foamy beverages, in particular milky beverages, directly from the sachet. Foamy beverages must be frothed in the drinking cup with a water jet as described in GB2374586. This implementation requires a longer time to prepare a foamy beverage (first for preparing the beverage from the sachet, secondly for frothing the beverage with the water jet) and does not give the feeling of a high quality beverage to the consumer.

WO 2011/024103 describes a pack for preparing a beverage defining an inner volume for storing the beverage ingredient. The inner volume is closed at its top by a rigid piece that integrates the water inlet and the beverage outlet. During the preparation of the beverage the beverage outlet is positioned at the top of the pack. Water is introduced until it fills the pack and overflows through the beverage outlet positioned at the top of the pack too. Such a pack is conceived for preparing a beverage by extraction of roast and ground coffee but not by dissolution of instant coffee or other soluble materials. For this reason the pack comprises a filter at the outlet to prevent insoluble particles from being dispensed with the beverage. An inconvenient of such a pack is that at the end of the preparation of the beverage and the introduction of water, beverage remains in the pack which is an issue for properly removing the pack from the beverage production machine. Besides in this pack neither the water inlet nor the beverage outlet is close by a membrane; then this implementation is not recommended in terms of hygiene and shelf life.

The presently disclosed and/or claimed inventive concept(s) proposes a pack for the preparation of a food or beverage that improves the hereabove problems in terms of manufacturing, beverage preparation simplicity and cleanliness leading to an optimal overall beverage quality.

### BRIEF DESCRIPTION OF THE DRAWINGS

The characteristics and advantages of the presently disclosed and/or claimed inventive concept(s) will be better understood in relation to the following figures.

FIGS. 1 to 7b illustrate packs according to the presently disclosed and/or claimed inventive concept(s).

FIGS. 8a to 8e illustrate the movement of the liquid in the inner volumes of packs of the presently disclosed and/or claimed inventive concept(s).

FIG. 9 illustrates the preparation of a beverage with a pack according to the presently disclosed and/or claimed inventive concept(s).

FIGS. 10 to 12 illustrate particular modes of introduction of a pack in a beverage preparation machine.

FIG. 13 illustrates a range of packs according to the presently disclosed and/or claimed inventive concept(s).

FIGS. 14a, 14,b, 14c and FIGS. 15a, 15b illustrate packs according to the fourth embodiment of the presently disclosed and/or claimed inventive concept(s).

FIG. 16 illustrates a method for manufacturing a pack according to the presently disclosed and/or claimed inventive concept(s).

FIG. 17 illustrates packs according to the third embodiment of the presently disclosed and/or claimed inventive concept(s).

FIGS. 18, 19, 20a, 20b and 20c illustrate a pack and its insert according to one particular, non-limiting embodiment of the presently disclosed and/or claimed inventive concept(s).

FIGS. 21a and 21b illustrate a variant of the insert of FIGS. 18 and 19.

FIGS. 22, 22b and 22c illustrate another variant of the insert of FIGS. 18 and 19.

FIGS. 23 and 24 illustrate a range of packs according to the presently disclosed and/or claimed inventive concept(s).

FIG. 25 is a partial section view of the second part 53 of the inlet chamber 32 of FIGS. 23 and 24.

FIGS. 26 and 27 describe the insert 5 of FIG. 23 before its insertion in the pack.

FIGS. 28 and 29 describe the insert 5 of FIG. 24 before its insertion in the pack.

FIGS. 30a and 30b illustrate an insert presenting two symmetric water inlets.

FIG. 31 illustrates the preparation of a beverage with a pack according to the presently disclosed and/or claimed inventive concept(s).

### DETAILED DESCRIPTION

Firstly the presently disclosed and/or claimed inventive concept(s) concerns a pack with an inner volume in which a food or beverage ingredient is stored and in which a beverage is produced when water is introduced inside, said pack comprising: at least one inlet configured for supplying a diluent in the inner volume of the pack, at least one outlet for dispensing a beverage from the inner volume of the pack, and wherein: the inlet and the outlet are positioned next to the bottom of the pack.

In the present application the terms “bottom”, “top”, “lateral”, “horizontal” and “vertical” are used to describe the relational positioning of features of the presently disclosed and/or claimed inventive concept(s). These terms should be understood to refer to the pack in its normal orientation when introduced in a beverage preparation machine for the production of a beverage as shown for example in FIGS. 9 to 12.

According to the presently disclosed and/or claimed inventive concept(s), “next to the bottom” means that both the inlet and the outlet are positioned on the bottom edge of the pack and/or on the bottom part of one of the lateral sides of the package. The presently disclosed and/or claimed inventive concept(s) covers the different variants where both the inlet and the outlet are on the same edge of the pack that is both on the bottom edge or both at the bottom part of a lateral side and where either the outlet or the inlet is on the bottom edge and respectively the inlet or the outlet is at the bottom part of a lateral side of the pack. According to the presently disclosed and/or claimed inventive concept(s), the bottom part of a lateral side of the pack generally corresponds to the part of said lateral side positioned below the middle part of the pack and may be closer to the bottom part of the pack rather than the middle part of the pack.

In the presently disclosed and/or claimed inventive concept(s), the term “water” covers any aqueous diluent that can be mixed with a soluble beverage ingredient to prepare a beverage, like water, carbonated water, milk. It is, in a particular, non-limiting embodiment, still water.

In certain, non-limiting embodiments, the pack comprises two flexible water impermeable sheets joined to one another to define the inner volume. As a consequence the pack itself is substantially flexible and looks like a pouch or sachet. By flexible, it is meant that the sheets can be bent easily. The resulting pack can be bent also; it is soft and can be deformed contrary to rigid containers. The flexible sheet material can be plastic laminates, metallised foil or alufoil or fibre base material. According to the presently disclosed and/or claimed inventive concept(s), the two flexible water impermeable sheets can be formed of one single flexible water impermeable sheet folded in half and joined at its free edges.

In certain non-limiting embodiments, the pack presents a generally plane shape. In a particular, non-limiting embodiment, the plane shape is essentially vertically oriented during beverage production.

In the presently disclosed and/or claimed inventive concept(s), the inlet and the outlet can be made in one single insert or two separate inserts positioned in the pack. In the presently disclosed and/or claimed inventive concept(s), the insert may be rigid. In a particular, non-limiting embodiment, the inserts are made of a rigid plastic material. This plastic material can be selected in the list of: polypropylene, polyethylene, polyethylene terephthalate and polylactic acid. According to another non-limiting embodiment, the insert can be made out of a metal like aluminium or tin-plate. The insert(s) can be injection molded.

In certain non-limiting embodiments, the outlet is configured so that it delivers the beverage as a free flow. The beverage can flow from the outlet by simple gravity fall. According to a particular, non-limiting embodiment, the outlet is an opening at the bottom of the pack, said opening having a transverse section with a surface area equivalent to the surface of a circular surface of diameter of at least 1 mm, such as but not limited to, at most 4 mm, or comprised between 1.5 and 3 mm. The outlet can be a straight tube oriented essentially vertically at the bottom of the pack. This tube can be pierced in an insert or can be a tube inside the bottom edge of the pack. In certain non-limiting embodiments, the length of the tube is of at least 5 mm. Such a length generally enables a finalisation of the froth of the beverage before it is delivered in the drinking cup. An advantage of the outlet of the pack of the presently disclosed and/or claimed inventive concept(s) is that there is no need to implement a particular connection between the beverage outlet and the beverage machine when a beverage is produced e.g. for directing the flow of beverage delivered at the outlet. The beverage can flow from the pack beverage outlet directly in a drinking cup.

The pack can comprise at least two water inlets. Depending on the kind of cooperation of the pack with the beverage preparation machine, in particular if the beverage outlet is positioned at the bottom centre of the pack, the pack can comprise two inlets symmetrically positioned around the beverage outlet. This embodiment renders the single insert and the pack symmetric; then the consumer can indifferently introduce it in one sense or another inside the corresponding beverage preparation machine.

The pack can comprise an excrescence enabling the handling of the pack.

The pack can comprise recognition means readable by the beverage preparation means. Such recognition means can be mechanical codes, optical codes, RFID tags, bar codes, magnetic codes.

According to the presently disclosed and/or claimed inventive concept(s), the food or beverage ingredient of the pack can be comprised within the list of: soups, fruit juices, vegetable juices, bouillons, coffee, chocolate, tea, milk or creamer, or a combination thereof. In certain non-limiting embodiments, the food or beverage ingredient is a soluble food or beverage ingredient. In a particular, non-limiting embodiment, the food or beverage ingredient is a soluble food or beverage ingredient selected in the list of: instant coffee powder, milk powder, cream powder, instant tea powder, cocoa powder, soup powder or mixture of said powders, a coffee concentrate, a milk concentrate, a syrup.

The powders can be agglomerated or sintered. The powders or liquid concentrates can be mixed with solid pieces for example for preparing soups with solid pieces.

According to a first, non-limiting embodiment of the presently disclosed and/or claimed inventive concept(s), the water inlet is (for example but not by way of limitation) configured for introducing water under the form of a jet in the inner volume of the pack. By jet it is understood a stream of liquid that comes out of the water inlet and in the inner volume of the pack quickly and with force. So the water inlet is configured for introducing water in the inner volume of the pack with a high velocity. In certain non-limiting embodiments, the water inlet is configured for introducing a water jet in the inner volume of the pack, said water jet presenting a velocity of at least about 20 m/s, such as but not limited to, at least 30 m/s. According to said first embodiment the water inlet is configured for transforming the pressurized water introduced by a beverage machine in the pack in a high velocity water jet in the inner volume of the pack. Such a configuration can be obtained by placing a constriction in the water path in the water inlet to reduce the size of the section of the water inlet. Due to the small surface of the inlet section pressurized creates a jet of water in the inner volume.

In general the water inlet comprises a hole presenting a transverse section with a surface area equivalent to the surface of a circular surface of diameter of at most 1 mm, such as (but not limited to)at least 0.24 mm.

The velocity for water emerging from the injection hole usually depends from the pressure of the water introduce at the water inlet. The presently disclosed and/or claimed inventive concept(s) generally applies for water pressurised between 2 and 10 bar, such as (but not limited to) of about 7 bar. For such values of pressurized water the water inlet generally comprises an injection hole presenting a transverse section with a surface area equivalent to the surface of a circular surface of diameter comprised between 0.2 and 0.8 mm, such as (but not limited to) between 0.3 and 0.5 mm, or of about 0.4 mm.

But when water is pressurized at more than 11 bar the water inlet (for example, but not by way of limitation) comprises an injection hole presenting a transverse section with a surface area equivalent to the surface of a circular surface of diameter comprised between 0.5 and 1.5 mm, such as (but not limited to) of about 1 mm.

The small surface of the injection hole presents the advantage of avoiding any back flow of liquid contained in the inner volume of the pack through the water inlet.

For the same diluent supply pressure the surface of the diluent injection hole can vary according to the nature of the food and beverage ingredient inside the pack. In particular when the ingredient is difficult to dissolve a smaller injection hole creates a jet with a higher velocity which improves agitation and dissolution in the pack.

According to the first non-limiting embodiment, the pack presents a plane shape oriented along a plane essentially vertically oriented during beverage production and the water inlet orientates the jet of water in a direction comprised in said plane. The water jet introduced from the bottom into the pack is developing into circular and spiral movements creating turbulences, frictions and high contact surfaces between the water molecules and the product particles. In average the water molecules have several turns within the sachet until they leave the sachet with the beverage. Best reconstitutions have been observed with a pack of rectangular shape. Packs with single insert placed in the corner of the rectangular pack also improve reconstitution.

The pack can present various external shapes like rectangular, square or round shapes. The inner volume of the pack can present the same shape as the external shape of the pack. According to one particular mode the inner volume can present a shape configured for improving the movement of the water and the beverage in the pack during beverage preparation. In particular for packs with external rectangular or square shapes, at least one of the inside corner, and in certain non-limiting embodiments both corners, can present a slanted shape. This feature avoids that beverage or food ingredient remains blocked in the right-angled corner. This feature can be obtained by sidewise sealing the corner of the pack.

According to a second embodiment of the presently disclosed and/or claimed inventive concept(s), the pack comprises one single insert including the water inlet and the beverage outlet, said single insert being positioned at the bottom of the pack. The single insert can be positioned at any place at the bottom of the pack between the both lateral sides of the bottom; it can be positioned at a bottom lateral side in particular a corner if the pack is globally rectangular or at any place between the corners. In the pack the water inlet and the beverage outlet of the pack are both simultaneously included in the same single insert. This feature covers the fact that the water inlet and the beverage outlet are part of the same insert piece in the pack. Yet this insert can be produced by the association of several parts before the complete piece is used for manufacturing the pack. In particular different parts can be clipped together to form the final single insert before said single insert is used for manufacturing the pack.

In certain non-limiting embodiments, the single insert of the pack presents a shape for cooperating with the pack receiving area of a beverage production machine. In particular it can present a shape configured for sliding in the slot of the receiving area of a beverage production machine like an iron shape.

According to one mode of this second embodiment the pack can present a generally plane shape, said plane shape presenting a face essentially vertically oriented during beverage production and the single insert being positioned at or next to the middle of the bottom of said face.

According to another mode of the is second embodiment the pack can present a plane shape, said plane shape presenting a face essentially vertically oriented during beverage production and the single insert being positioned at or next to a bottom corner of said face.

According to certain non-limiting embodiments, the presently disclosed and/or claimed inventive concept(s) concerns a pack with an inner volume in which a food or beverage ingredient is stored and in which a beverage is produced when water is introduced inside, said pack comprising at least one inlet for introducing water in the inner volume and at least one outlet for delivering the beverage from said inner volume, the pack comprising one single insert including the water inlet and the beverage outlet, wherein: the single insert is positioned at the bottom of the pack, the water inlet is configured for introducing water under the form of a jet in the inner volume of the pack.

According to a third embodiment of the presently disclosed and/or claimed inventive concept(s), before beverage preparation step, the beverage outlet is closed at its end. Generally the beverage outlet is closed by manufacturing and is configured for being opened at beverage production step. By “closed by manufacturing” it is meant that the pack is manufactured with a closed beverage outlet. This closure guarantees hygienic and shelf life protection. The outlet can be opened by a machine or manually.

In certain non-limiting embodiments, the beverage outlet is closed by a plug, said plug comprising means for maintaining it attached to the pack after the opening of the beverage outlet. Consequently the plug does not fall in the beverage during its production. The means for maintaining the plug attached to the pack can be a plastic bond attached to the single insert.

The beverage outlet can present a weakening zone near the plug. This weakening zone can be a narrowing of the outlet tube so that it can be made easy to cut or tear off the plug with the beverage preparation machine.

In certain non-limiting embodiments, the plug is part of one single insert comprising the beverage outlet and the water inlet. In particular when the insert is injection molded, the design of the injection molded insert comprises the plug. In the same manner the plastic bond is part of the design of the single insert if it is injection molded. This injection moulding of the insert, the plug and the bond in one single piece enables again to reach several aims with the use of only one material: the plastic for producing the insert comprising the water inlet and the beverage outlet is used to close the external end of the beverage outlet.

Whatever the above described embodiments the water inlet can be oriented in the pack according to two different variants.

According to one first variant the water inlet can be positioned in the pack so that it is almost totally essentially vertically oriented during the beverage production. Then the water inlet can be placed at any part along the bottom of the pack. Usually according to this first variant the water inlet is a straight tube, such as but not by way of limitation, in an insert positioned at the bottom of the pack. The insert can be positioned between two flexible water impermeable sheets joined to one another and forming the inner volume. In this first variant the water inlet and the beverage outlet are usually globally parallel vertically oriented tubes.

According to a second variant the water inlet can be at least partially essentially horizontally oriented during beverage production. In this second variant the water inlet and the beverage outlet are globally perpendicular one to the other. According to this second variant the water inlet is generally positioned in one lateral side of the pack and next to the bottom of said lateral side.

In a first mode of this second variant the water inlet can be an almost straight tube in an insert; accordingly the water inlet is configured so that there is no change of direction of the flow water from the external end of the water inlet until the internal end of the water inlet. In certain non-limiting embodiments, said insert is positioned between the two flexible water impermeable sheets joined to one another.

In a second mode of this second variant the water inlet can be configured so that the direction of the water flow in the external end of the water inlet is almost perpendicular to the direction of the water flow in the internal end of the water inlet. In this embodiment the internal design of the water inlet enables a globally perpendicular change of orientation of the water flow from the external end of the water inlet (that faces the external part of the pack) to the internal end of the water inlet (that faces the internal part of the pack).

In said second non-limiting embodiment, the external end of the water inlet may comprise an inlet chamber which comprises an evacuation end, said evacuation end being an injection hole configured for directing a jet of water in the inner volume of the pack in a direction almost perpendicular to the inlet chamber longitudinal axis. In certain non-limiting embodiments, the inlet chamber is globally horizontally oriented. This chamber is usually configured for receiving a hollow needle for injecting water. It generally presents a circular section. This chamber presents the advantage of creating a distance between the end of the hollow needle and the inner volume which stores the beverage ingredient and consequently avoids the contamination of the needle. The evacuation end can be configured for delivering water under the form of a jet in the inner volume of the pack as described in the above first embodiment. In a particular, non-limiting embodiment, the chamber evacuation end is a hole pierced in the lateral wall of the chamber.

In certain non-limiting embodiments, the pack presents a generally plane shape essentially vertically oriented during beverage production. According to the present second mode of the second variant for the water inlet the inlet chamber is (in particular, non-limiting embodiments) perpendicular to said plane. Then the water inlet and the beverage outlet are generally perpendicularly oriented one to the other. Consequently the inlet and the outlet emerge on different sides of the pack. This configuration limits the contamination risk of the means for introducing water in the water inlet by the beverage dispensed by the beverage outlet.

Whatever the variant and the mode for the water inlet said water inlet can be configured for orienting the water jet in direction of the beverage outlet. Such a configuration enables the agitation of the beverage by the inlet water jet before the before the beverage evacuates from the beverage outlet. According to a particular mode the packs designed for producing a jet of water that is globally horizontally oriented are particularly interesting for avoiding the clogging of the food or beverage ingredient. The water jet avoids that the beverage flows through the outlet too rapidly and increases the time of agitation of the ingredient in the pack.

According to a fourth embodiment the pack comprises: two flexible water impermeable sheets joined to one another to define the inner volume, and one insert including at least one water inlet, and wherein the water inlet is enclosed in the pack by the sheets defining the inner volume.

According to a particular non-limiting embodiment, the two flexible water impermeable sheets can be formed of one single flexible water impermeable sheet folded in half and joined at its free edges. According to said mode the pack is a plane pack made of a flexible material sheet, said sheet being folded at the top of the pack and bonded on its edges to define the inner volume, the bottom bonded edge including the insert. This embodiment constitutes a particularly easy way to manufacture the pack since it requires the cutting of only one piece of sheet—and in particular (but not limited to) according to a rectangular shape—and its folding to create the inner volume for the food or beverage ingredient. The single can be introduced in the bottom edge during the sealing of the edges.

The water inlet is enclosed in the pack by the sheet(s) of material that defines the inner volume of the pack. In particular the external end of the water inlet is covered and closed by said sheet of material. Consequently the same piece of material can be used to simultaneously create the inner volume of the pack, close the water inlet and protect the external end of the water end. Due to the enclosure of the beverage inlet in the pack there is no need for a particular membrane for closing the water inlet. The presently disclosed and/or claimed inventive concept(s) provides a pack that is easy to manufacture and guarantees hygienic and shelf life protection of the food and beverage ingredient and the produced beverage.

In the presently disclosed and/or claimed inventive concept(s), the external end of the water inlet represents the end of the water inlet channel that cooperates with a water supply at the outside of the pack whereas the internal end of the water inlet represents the end of the water inlet channel that delivers water inside the pack. Similarly in the present text the external end of the beverage outlet represents the end of the beverage outlet channel that dispenses beverage at the outside of the pack whereas the internal end of the beverage outlet represents the end of the beverage outlet channel that is inside the pack.

In certain non-limiting embodiments, the external end of the water inlet in the insert is closed by the sheet bottom bonded edge. Due to the introduction of the single insert in the bottom edge during the sealing of the edges, the sheet can cover the part of the insert including the water inlet. Consequently during the single step of bonding the edges of the sheet, it is possible to simultaneously create the inner volume for storing the beverage ingredient, place the insert and close the water inlet external end. In certain non-limiting embodiments, the beverage outlet is not covered by the sheet. Yet it can be visually hidden by a part of the sheet e.g. by a skirt of the sheet. In certain non-limiting embodiments, the single insert presents ribs on its external surface for improving the adhesion with the flexible material sheet during sealing. In particular a raising edge can surround the water inlet so as to improve air and water tightness around it.

According to a particular mode the inner volume of the pack presents a generally plane shape defining a plane P essentially vertically oriented during beverage production, and the insert is configured and positioned in the pack so that the longitudinal axis of the water inlet channel at its external end is almost perpendicular to said plane, and the at least one sheet of material defining the inner volume covers the external end of the water inlet channel. In certain non-limiting embodiments, the insert is configured so that the longitudinal axis of the water inlet channel at its internal end is almost comprised in the vertically oriented plane P.

As illustrated in the drawings the different embodiments of the pack described hereabove can be combined together.

Secondly the presently disclosed and/or claimed inventive concept(s) concerns a range of packs such as described hereabove wherein the packs differ by the size of the inner volume and/or the internal dimension of the outlet and/or the internal dimension of the inlet and/or the orientation of the inlet and/or the orientation of the outlet. A wide range of different sachets can be used for producing different types of food or beverages. The external design of the insert remains the same whereas the inner volume of the pack can be adapted to store different quantities of ingredient. It becomes possible to produce a cup of espresso coffee or a bowl of soup. The internal design of the insert can be adapted according to the nature of the food or beverage ingredient inside the pack.

According to an embodiment of the presently disclosed and/or claimed inventive concept(s), the range of packs such as described hereabove can comprise at least two types of packs essentially differing by their ability to produce a foamy beverage or a non-foamy beverage. The first type of pack that is able to produce a foamy beverage generally presents a water inlet configured for introducing a water jet in the inner volume of the pack with a higher velocity than the second type of pack. The first type of pack (in certain non-limiting embodiments) presents a beverage outlet configured for keeping the beverage as long as possible in the inner volume of the pack. Then the injection hole of the first type of pack presents a beverage outlet with a surface area equivalent to the surface of a circular surface of diameter smallest than for the second type of pack. The first type of pack also (in certain non-limiting embodiments) presents shape configured for improving the movement of the water and the beverage in the pack during beverage preparation. It has been observed that rectangular packs presenting a ratio length/width of about 4/3 and with the single insert placed at the width side improves the agitation of the liquid and the generation of foam. This effect is even more improved when the insert is positioned at the side corner of the width with the length. The foaming of the beverage can also depend from the nature of the food or beverage ingredient.

This particular, non-limiting embodiment enables the production of a range of different packs adapted for the agitation and dissolution of different types of beverage or food ingredients.

According to a particular embodiment, the presently disclosed and/or claimed inventive concept(s) concerns a range of packs, wherein the pack comprises one single insert including the water inlet and the beverage outlet, said insert being positioned at the bottom of the pack and wherein the single insert is made of two parts, a first part comprising the beverage outlet and a second part comprising the water inlet, each of the first part and the second part comprising a fastener for attaching and positioning one to the other, and wherein the water inlet comprises an inlet chamber comprising an evacuation end, said evacuation end being a hole pierced in the lateral wall of the chamber, wherein the packs differ by the relative orientations of their second part to their first part.

The second parts can differ by the distance in between the hole pierced in the lateral wall of the chamber and the fastener for attaching and positioning the second part to the first part. As a consequence when the first and second parts are attached together to form the single inserts, said inserts packs differ by the orientation of the hole pierced in the lateral wall of the chamber that is the orientation of the water jet in the inner volume of the pack.

According to the particular, non-limiting embodiment, the second part comprising the water inlet is attached to the first part comprising the beverage outlet by a hinge, and the fasteners of the first part and the second part for attaching and positioning one to the other are hooks configured and positioned on each part for being hooked together when the hinge is closed. The length of the hook of either the first part or the second part can vary so that the relative orientation of the second part to the first part varies.

This particular embodiment enables the production of a range of different packs adapted for the agitation and dissolution of different types of beverage or food ingredients.

Thirdly the presently disclosed and/or claimed inventive concept(s) concerns a method for the preparation of a food or beverage comprising the steps of: providing a pack such as described hereabove or a pack from a range of packs such as described hereabove and positioning said pack with the insert positioned downwardly, injecting water into the pack to mix with the food or beverage ingredient, allowing the prepared beverage to escape through the outlet into a receptacle.

In certain non-limiting embodiments, the method is implemented by a beverage production machine in which the different steps are implemented. The water is generally injected by piercing the pack with a hollow needle at the water inlet of the pack.

In certain non-limiting embodiments, the water inlet is opened at the same time or after the opening of the beverage outlet. According to this particular, non-limiting embodiment, the beverage is prepared with the both inlet and outlet being opened. Then the beverage is not prepared in the pack under pressure or under pressure increase.

Fourthly the presently disclosed and/or claimed inventive concept(s) concerns a machine for preparing a beverages from a pack such as described hereabove, said pack comprising a beverage outlet closed by a plug, said machine comprising at least: a water supply, a pump for pumping water from the water supply. a water needle for injecting water in the water inlet of the pack, a device for cutting or tearing the plug of the beverage outlet of the pack.

The device for cutting or tearing the plug can be positioned so that the plug of the beverage outlet is automatically cut when the pack is introduced in the machine or when the beverage preparation is activated.

In certain non-limiting embodiments, the machine comprises an area for positioning a drinking cup under the beverage outlet of the pack when a beverage is prepared.

Generally the machine comprises an area for receiving the pack configured for positioning the pack so that the single insert is positioned at the bottom of the pack.

Lastly the presently disclosed and/or claimed inventive concept(s) concerns a method for manufacturing a pack such as described hereabove, the pack comprising one single insert including the water inlet and the beverage outlet, wherein the method comprises the steps of:

folding a sheet of material and bonding the both lateral edges to form a pouch,

filling the pouch through the last opened edges with a food or beverage ingredient,

positioning the single insert between the opened edges and bonding said edges.

Turning now to the Drawings, FIG. 1 illustrates a pack 1 for producing a beverage according to the presently disclosed and/or claimed inventive concept(s). The pack comprises two flexible water impermeable sheets joined one to another on their edges 111, 112, 113, 114 to define an inner volume 2. These two sheets can be obtained by folding one sheet in its middle to form the top 114 of the pack too; then only edges 112, 112, 113 have to be bonded together as illustrated in FIG. 16. The bonding can be obtained by heat sealing. A beverage material is disposed within said inner volume. The pack comprises one inlet 3 configured for supplying water 11 in the inner volume 2 of the pack and one outlet 4 for dispensing a beverage 7 from the inner volume of the pack 2. The both inlet and outlet are positioned at the bottom of the pack at the bottom side 111 of the pack. The water inlet 3 and the beverage outlet 4 can be materialised as straight holes in respective rigid inserts 51, 52 enclosed inside the bottom bonded edge 111 of the pack.

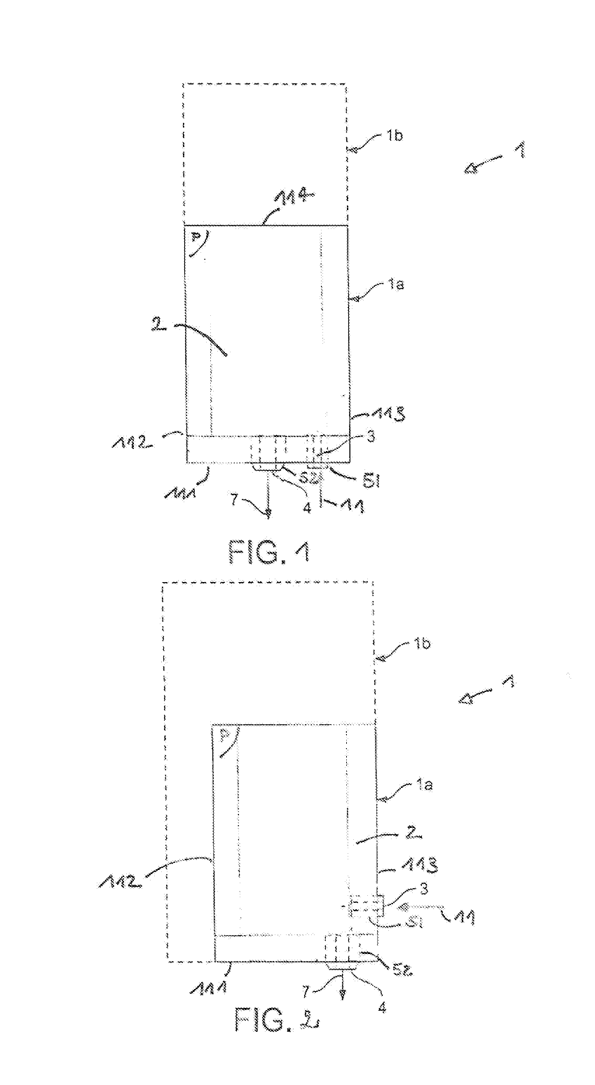

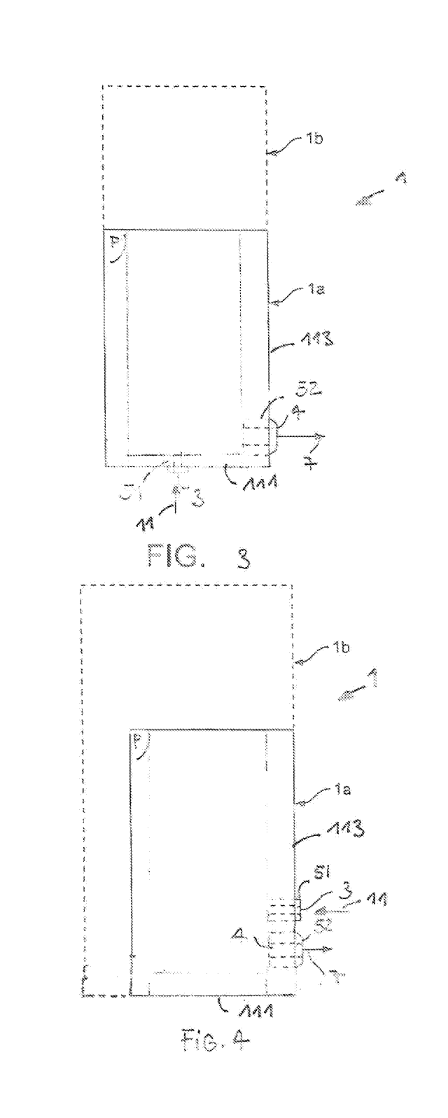

FIG. 2 illustrates a variant of the pack of FIG. 1 wherein the water inlet 3 is positioned next to the bottom of the pack in the lateral side 113 of the pack.

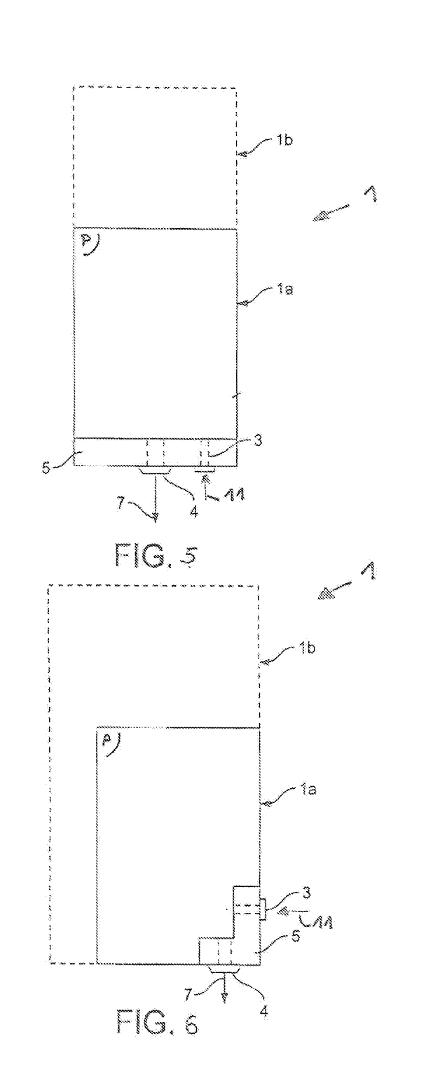

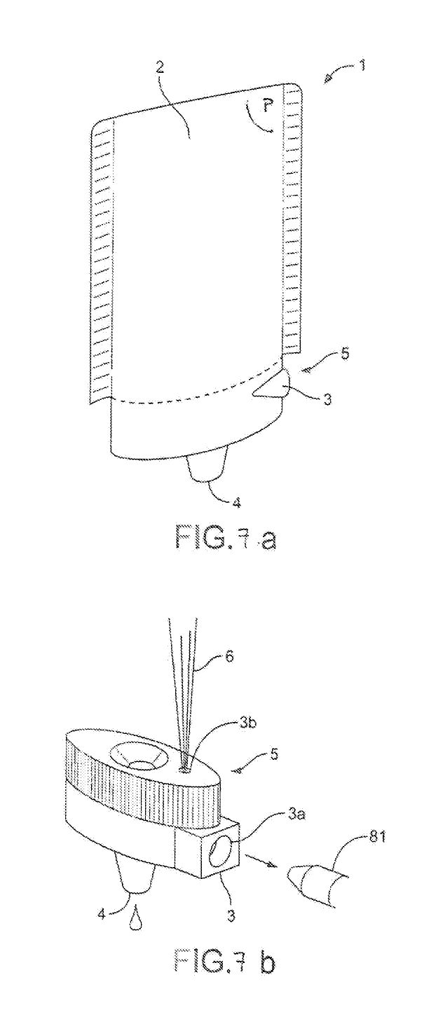

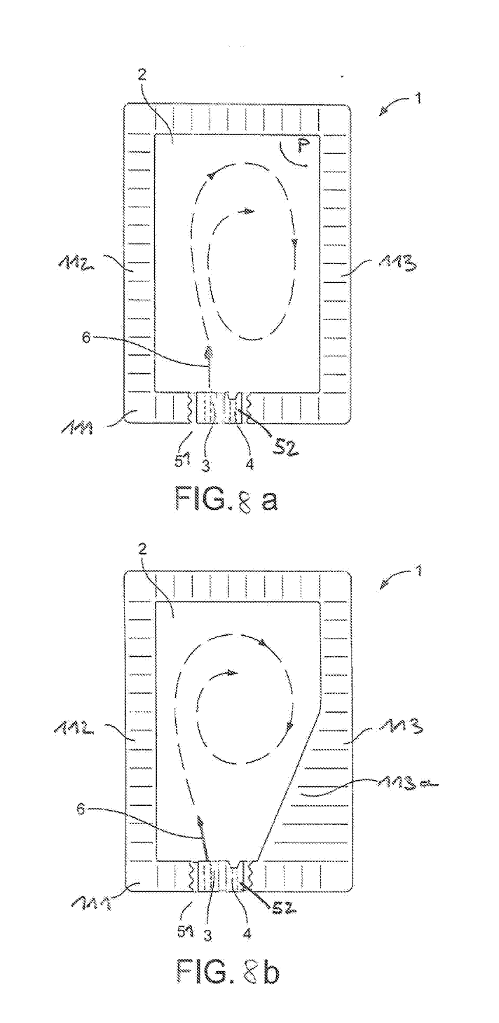

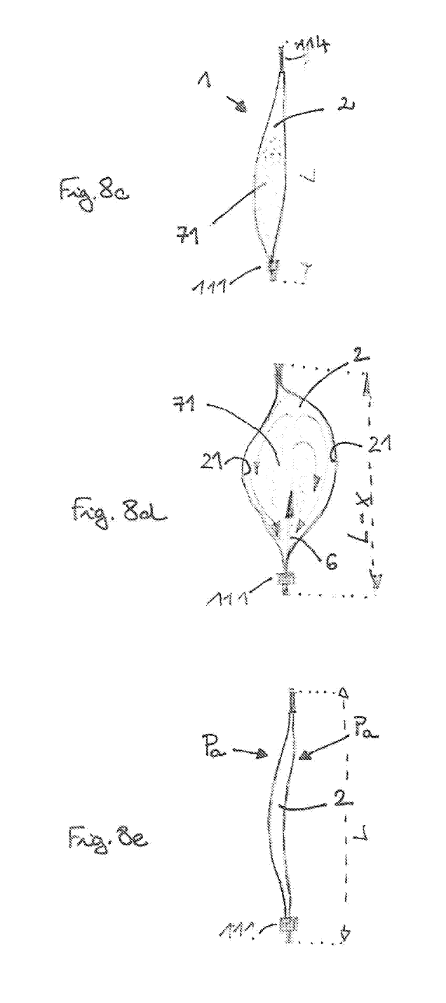

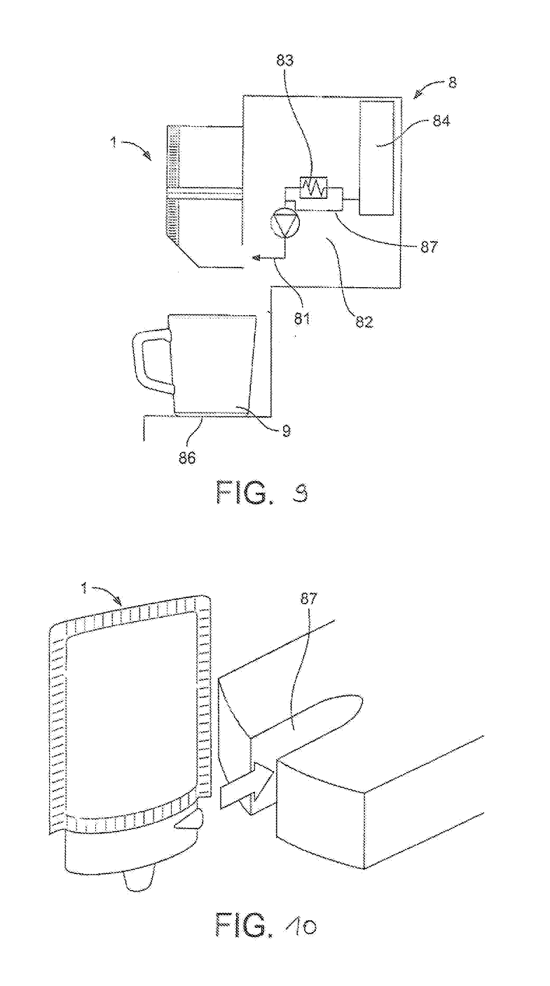

FIG. 3 illustrates another variant of the pack of FIG. 1 wherein the water inlet 3 is still at the bottom bonded edge 111 of the pack but the beverage outlet 4 is positioned next to the bottom of the pack in the lateral side 113 of the pack.

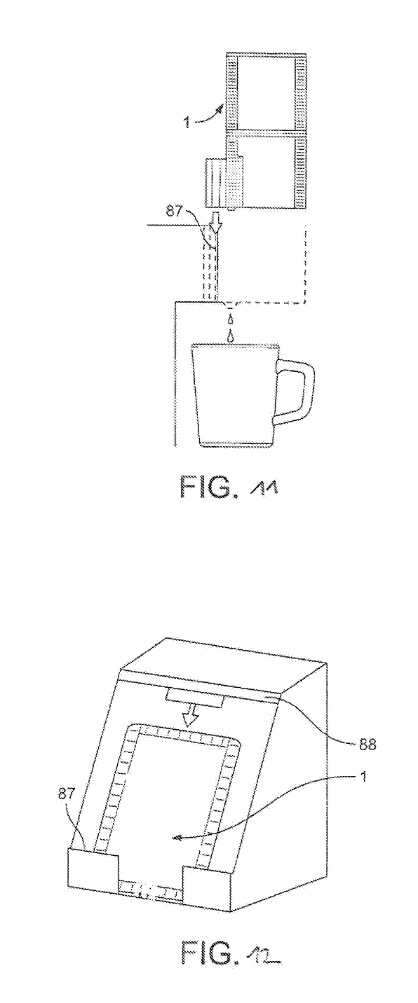

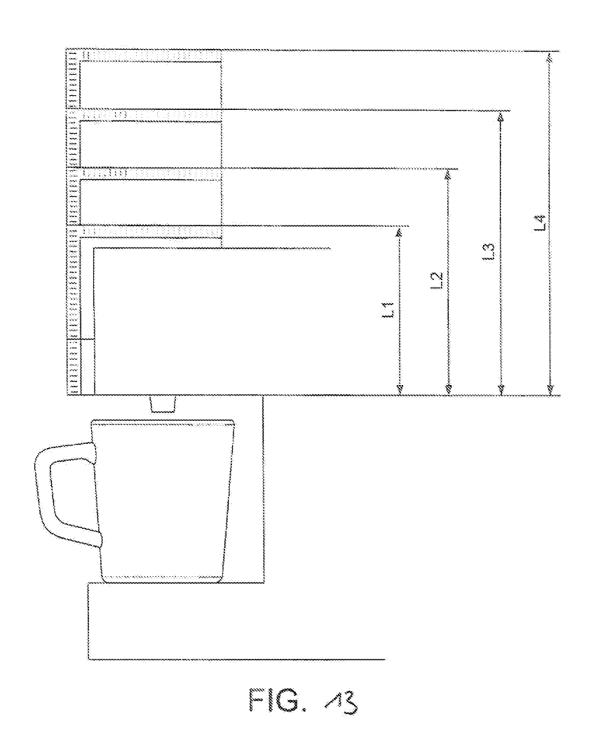

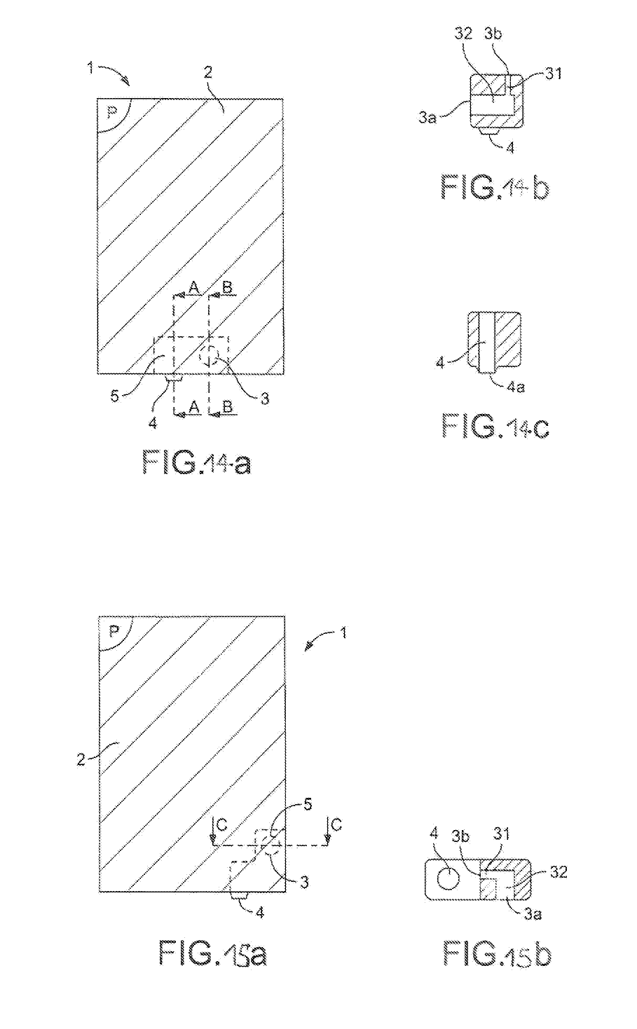

FIG. 4 illustrates another variant of the pack of FIG. 1 wherein the both water inlet 3 and beverage outlet 4 are positioned next to the bottom of the pack in the lateral side 113 of the pack. In said later variant the inlet 3 is (in certain non-limiting embodiments) positioned above the outlet 4 in the lateral side bonded edge 113 of the pack.

FIGS. 5 and 6 illustrates respective variants of FIGS. 1 and 2 in which the inlet 3 and the outlet 4 are in the same single insert 5 rather than in two separate inserts 51, 52 according to the second embodiment of the presently disclosed and/or claimed inventive concept(s).

In the embodiment illustrated in FIGS. 1, 3 and 5 the water inlet 3 is configured for introducing the water jet upwardly and vertically. Yet as illustrated in FIGS. 2, 4 and 6 the water inlet 3 could also be a straight hole essentially horizontally oriented and introducing the water jet essentially horizontally inside the inner volume 2. According to the embodiments of FIGS. 2 and 6 a jet of water can cross the internal end of the beverage outlet.

As illustrated in dotted lines in FIGS. 1 to 6 small packs 1a or big packs 1b can be produced with the same inserts 51, 52 and 5. Consequently it is possible to produce range of packs 1a, 1b differing by the size of the inner volume 2 and configured for preparing beverage with the same beverage preparation machine. The possibility to create a range of packs with the same insert is also illustrated in FIG. 13.

For all the variants inlets and outlets can be straight holes inside inserts because they are easy to manufacture. Yet other embodiments wherein the inserts define holes with at least one change of direction can be implemented also. Such a change of direction can be helpful to improve the interface of the inserts with the beverage preparation machine, in particular the interface between the machine water supply and the water inlet insert. Such a change of direction can be helpful to control the water velocity in the inner volume of the pack and/or the water jet orientation in the inner volume of the pack also. The single insert presents the advantage of being easily positioned in the edges of the pack when it is manufactured compared to two inserts.

FIGS. 7a and 7b illustrate variants of the second embodiment of the presently disclosed and/or claimed inventive concept(s), wherein the inlets and the outlets are holes inside one same single insert 5. These figures also illustrate a water inlet 3 that is not straight: the direction of the flow water at the external end 3a of the water inlet is almost perpendicular to the direction of the flow water at the internal end 3b of the water inlet. Such an insert enables cooperation with a beverage machine presenting a configuration such as described in FIG. 10. The pack presents a generally plane shape: it is oriented along a plane P essentially vertically oriented during beverage production when the water nozzle 81 of a beverage preparation machine is introduced in the water inlet external end 3a as illustrated in FIGS. 7b and 10. The pack can be almost flat in the direction perpendicular to plane P.

In all the precedent figures the beverage and the water holes differ by their sizes generally. In certain non-limiting embodiments, the beverage outlet 4 presents a sufficient section so as to enable a free flow of the beverage from the pack. The beverage 7 can freely flow in a drinking cup placed under the outlet 4. In certain non-limiting embodiments, the outlet 4 can be a hole having a transverse section with a surface area equivalent to the surface of a circular surface of diameter of at least 1 mm, such as but not limited to, at most 4 mm, or comprised between 1.5 and 3 mm.

Due to the orientation of the pack the food or beverage ingredient usually stands at the bottom of the inner volume 2 when the pack is in position for beverage preparation. Consequently when water is introduced in the insert 51 next to the bottom of the pack it immediately penetrates the food or beverage ingredient and agitates it. The dissolution starts very rapidly. Moreover as the beverage or food issued from the dissolution of the ingredient with water flows down in the pack then said beverage or food is agitated again as long as water is introduced in the pack.

According to the first embodiment of the presently disclosed and/or claimed inventive concept(s), the section of the water inlet 3 is configured so as to create a jet of water inside the inner volume 2. The water inlet 3 is configured for introducing the water jet in the inner volume of the pack at a high velocity. This velocity aims at: agitating the food or beverage ingredient in the inner volume 2, maintaining a circulation the food or beverage ingredient, the water and the resulting beverage in the inner volume 2 and avoiding that food or beverage ingredient is dispensed by the beverage outlet 4 before it has been sufficiently agitated and dissolved.

Depending on the nature of the food or beverage ingredient the high velocity water jet can create an emulsion with the water and the fats or oils issued from the ingredients. As a result a beverage with particular good mouthfeel can be obtained. In the case of production of a coffee espresso, a coffee with crema can be directly obtained from the pack without adding particular foaming additives in the beverage ingredient or without post treating the beverage to get the desired crema.

According to the presently disclosed and/or claimed inventive concept(s), a water jet presenting a velocity of at least 20 m/s enables an optimal dissolution of food or beverage ingredient in the inner volume. A jet of water with high velocity can be created in the inner volume by injecting water through a small orifice. The water inlet can present a small section along all its length or it can present a constriction presenting such a small section. Usually this last implementation is desired (but is not considered limiting). The size of the section to get a jet of water in the inner volume usually depends from the pressure of the water introduced in the water inlet by of the beverage preparation machine. A transverse section with a surface area equivalent to the surface of a circular surface of diameter comprised between 0.3 and 0.5 mm such as (but not limited to) of about 0.4 mm is particularly adapted for water delivered at the water inlet external end at a pressure comprised between 2 and 10 bar.

The water inlet is configured for transforming the high pressure water introduced by the beverage machine in the pack in a high velocity jet in the inner volume of the pack. The shape of the small section can be of any kind. Circular section is desired in certain non-limiting embodiments for easy manufacturing.

FIG. 8a illustrates the movement of the liquid in the inner volume 2 of a pack 1 in the main plane P. The pack 1 presents lateral and bottom sealed edges 111, 112, 113. The bottom sealed edge 111 has been made partly transparent to show the inserts 51 and 52 comprising respectively the inlet 3 and the outlet 4. In such a pack the water jet 6 emerges with high velocity from the inlet 3 placed at the bottom, then flows upwardly and develops in a circular and spiral movement inside the main plane P of the pack. Due to this movement the liquid in the inner volume is not directed to the outlet 4 and keeps moving according to this movement as long as water is introduced through the inlet. The movement enables agitation and optimised dissolution of the food or beverage ingredient. Once the water is no more introduced in the pack or once water totally fills the inner volume beverage flows out of the pack through the beverage outlet 4. The outlet section is sufficiently large to create a gentle flow in the dinking cup placed under the outlet. The pack totally empties due to the position of the outlet next to the bottom of the pack.

FIG. 8b illustrates a pack presenting an optimised internal shape of its inner volume. It presents the same feature as the pack of FIG. 8a except that the seal on one of the lateral edge 113 is made larger at the bottom corner of the pack so as to configure the inner volume 2 with as slanted internal corner 113a. The water jet 6 emerging from the inlet 3 develops in a circular movement and the slanted edge 113a reinforces this movement alive by reorienting the movement upwards when it comes downwards. Such an embodiment can be particularly interesting for food or beverage ingredients that are difficult to dissolve and that must be strongly agitated. This configuration also enables to guide and push all the dose of food or beverage ingredient above the water inlet in the inner volume 2. Then the contact between the food or beverage ingredient and water is improved at the point where the water flow presents its higher velocity and agitation strength.

Although the bottom corner 113a is represented as completely internally sealed, it is also possible to create a simple sealing line inside the inner volume 2 to prevent liquid from circulating in the corner.

FIGS. 8c, 8d, 8e are longitudinal section views of a pack during different stages of the preparation of a beverage. FIG. 8c is a section of the pack 1 at rest before introduction of water inside the pack with the bottom edge 111 positioned at the bottom and the edge 114 at the top inside the machine. The beverage ingredient 71 rests at the bottom of the inner volume 2. The pack extends along a length L between its two edges 111, 114.

FIG. 8d shows the same pack during the introduction of water through the water inlet at the bottom of the pack. A jet of water 6 flows essentially vertically from the bottom to the top of the pack. In the main plane P of the pack the jet develops in circular movements as illustrated in FIG. 8a. During the beverage preparation only the bottom of the pack cooperates with the beverage preparation machine while the top of the pack remains free. Consequently when water is introduced in the pack, due to the flexible nature of the sheet material of the pack and the freedom of movement of the pack top edge 114, the inner volume 2 of the pack can inflate. This inflation occurs mainly in the direction perpendicular to the main plane P. Then once the jet of water 6 has reached the top of the pack a part of water can also flow down through this inflated volume perpendicular to the main plane P. Here it has been observed that water flow is induced to follow the internal surface 21 of the inner volume. It follows that no beverage ingredient 71 can remain undissolved inside the inner volume 2: the ingredient 71 is kept at the middle of the inflated volume and maintained or directed to the fluid circular movement described in FIG. 8a. Another advantage of the fact that water flow is induced to follow the internal surface 21 of the inner volume is that at the end of the beverage preparation the inner chamber 2 is rinsed very effectively and no product remains in the pack.

FIG. 8e illustrates the pack at the end of the beverage preparation. The beverage is delivered from the pack as soon as the inner volume 2 of the pack is full of water or as soon as the introduction of water in the pack is stopped since the beverage outlet is opened at the bottom. The beverage flows by gravity and its delivery is forced by the pack returning to its original shape and length L under the pressure of atmospheric pressure Pa. The emptying is efficient.

FIG. 9 illustrates the interaction of a pack according to the presently disclosed and/or claimed inventive concept(s) with a beverage preparation machine 8. The machine comprises at least: a water tank 84, a heater 83 for heating water. The heating can deliver water at a temperature comprised between a bypass line 87 for delivering ambient water, a valve (not illustrated) for the selection of either hot or ambient water, a pump 82 for pumping water. The pump can deliver water at a pressure comprised between 2 and 10 bar, a water nozzle or needle 81 for injecting water in the water inlet of the pack 1.

In certain non-limiting embodiments, the machine comprises an area 86 for positioning a drinking cup 9 under the beverage outlet of the pack when a beverage is prepared.

The machine comprises an area for receiving the pack that is configured so that the pack 1 is positioned so that the single insert is positioned at the bottom of the pack.

According to the presently disclosed and/or claimed inventive concept(s), the pack is not pressurized during the beverage preparation. This effect can be obtained by opening the beverage outlet before water is introduced in the pack or simultaneously to the introduction of the water in the pack. Consequently the beverage is prepared with the both inlet and outlet being opened. The opening of the inlet is usually made by a needle for introducing water. As for the beverage outlet it can be opened by the machine when the pack is placed inside or by the user manually. Although the beverage positioned at the bottom of the pack is opened during the beverage preparation it has been observed that no beverage flows from the outlet at least as long as water is introduced through the inlet. The jet of water maintains a sufficient agitation of the liquid in the inner volume to prevent beverage from flowing out without having been sufficiently agitated.

The machine can comprise beverage outlet opening means.

The machine can comprise means for reading pack recognition means in particular to assist use of the pack in a fully automated beverage production machine. The machine can read projections, perforations, a bar code, an optical code, a magnetic tag or an RFID tag of the pack.

FIGS. 10 to 12 illustrate examples of machine pack receiving area for introducing the pack 1 in the machine: FIG. 10 illustrates the introduction according to a globally horizontal sliding movement whereas FIG. 11 illustrates the introduction according to a vertical sliding movement and FIG. 12 illustrates the simple positioning of the pack on a slightly slanted plane and the closure of a sliding cover 88—e.g. a transparent cover—above the pack to launch the beverage preparation. Other receiving area and movements are possible depending on the positions of the water inlet in the pack (horizontally or vertically oriented, perpendicular to or inside the main plane of the pack) and on the position of the insert in the pack (in the corner, in the middle of the bottom).

FIG. 13 illustrates the possibility to create a range of packs with the same insert consequently it is possible to produce range of packs 1a, 1b differing by the size of the inner volume 2 (L1, L2, L3, L4) and configured for preparing beverage with the same beverage preparation machine.

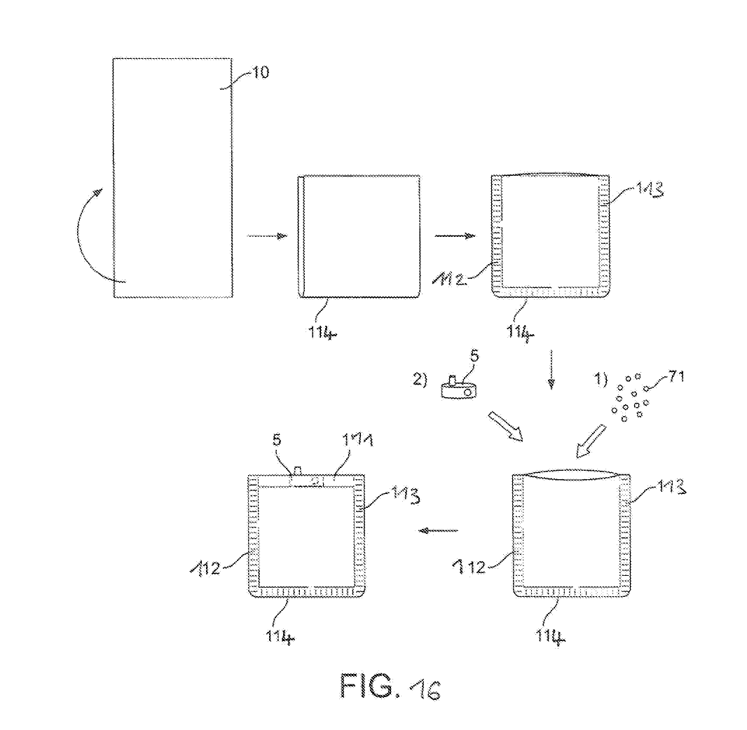

FIG. 14a is a simplified illustration of pack according to the fourth embodiment of the presently disclosed and/or claimed inventive concept(s) comprising an inner volume 2 in which a food or beverage ingredient is stored. The pack comprises at its bottom a single insert 5. The dotted lines correspond to the parts of the insert enclosed inside the pack. The insert 5 includes simultaneously a water inlet 3 for introducing water in the inner volume and a beverage outlet 4 for dispensing the beverage or food issued from the mixing of the food or beverage ingredient with water. The pack presents a generally plane shape. It is oriented along a plane P essentially vertically oriented during beverage production as illustrated in the FIG. 14a. This plane shape is essentially provided by the material that creates and designs the inner volume 2 of the pack; this material presents the shape of a sheet. Said sheet provides the plane shape to the pack. In FIG. 14a the insert 5 is positioned at the centre of the bottom of the pack, yet it could be positioned at any other position between the two lateral ends of the bottom.

The internal designs of the water inlet and the beverage outlet are respectively illustrated in FIG. 14b, which is a view according to section B-B, and FIG. 14c, which is a view according to section A-A. FIG. 14c shows that the beverage outlet 4 is a straight vertical hole pierced in the insert 5. In certain non-limiting embodiments, the beverage outlet 4 presents a sufficient section so as to enable a free flow of the beverage from the pack. The beverage can then freely flow in a drinking cup placed under the beverage outlet 4. FIG. 14b shows that the external end 3a of the water inlet is oriented so as to be closed by the sheet of material that creates and designs the inner volume 2 of the pack. Said external end 3a comprises and inlet chamber 32. Said chamber present an evacuation hole 31 in its lateral upward wall so as to orient the water flow, such as (but not limited to) in the form of a jet, in the inner volume 2 inside the plane P.

The sheet of material that defined the inner volume 2 covers at least the part of the insert 5 so that the water inlet 3 is enclosed in the pack. Consequently the external end 3a of the water inlet is closed by the material that defines the inner volume of the pack. In the embodiment illustrated in FIG. 14a a part of the beverage outlet—that is its external end 4a—is not enclosed in the pack.

FIG. 15a is a variant of the pack of FIG. 14a wherein the insert 5 presents an L-shape and is placed in the corner of the inner volume of the pack. The beverage outlet 4 presents the same feature as in the pack of FIG. 14a. The water inlet is positioned in the upper part of the L-shape insert. The internal shape of the water inlet is illustrated in FIG. 15b that is view of the insert 5 according to section C-C. The external end 3a of the water inlet comprises an inlet chamber 32 that is closed by the material that defines the inner volume of the pack. The chamber presents an essentially horizontal evacuation hole 31 in its lateral wall so as to orient the water flow, such as (but not limited to) in the form of a jet, in the inner volume 2 inside the plane P.

Although FIGS. 14a, b, c and 15a, b illustrates packs with single insert 5, packs can be made with different inserts for the water inlet 3 and the beverage outlet 4.

FIG. 16 illustrates a method for manufacturing a pack according to the presently disclosed and/or claimed inventive concept(s) from a flexible sheet of material. First the sheet of material 10 that presents (in certain non-limiting embodiments) a rectangular shape is folded in its middle and the superposed lateral edges are bonded together which creates pouch with bonded lateral edges 112, 113 and a folded edge 114. The folded edge 114 can also eventually be sealed to give a comparable aspect as the lateral edges for aesthetic aspect. Then food or beverage ingredient 7 is introduced in the pouch. Then the single insert 5 is placed between the two last opened edges and these edges are bonded together and around the insert to simultaneously close the pack, position the insert and close the water inlet. According to another particular, non-limiting embodiment, the inserts of the beverage outlet and the water inlet can be separated.

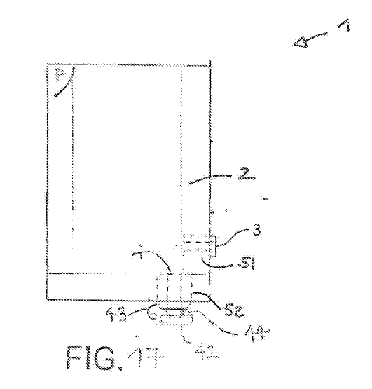

FIG. 17 illustrates the third embodiment of the presently disclosed and/or claimed inventive concept(s). The beverage outlet 4 is closed at its external end by a plug 42. This plug is made of one piece with the rest of the insert 52 in which the outlet if defined. During beverage production this plug is cut or torn for opening the beverage outlet. The insert comprises also a plastic bond 43 for maintaining the plug attached to the pack after the opening of the beverage outlet. Consequently it is avoided that the plug falls in the beverage during its production. The beverage outlet also presents a weakening narrow zone 44 near the plug 42 so that said plug can be made easy to cut or tear off the plug with the beverage machine.

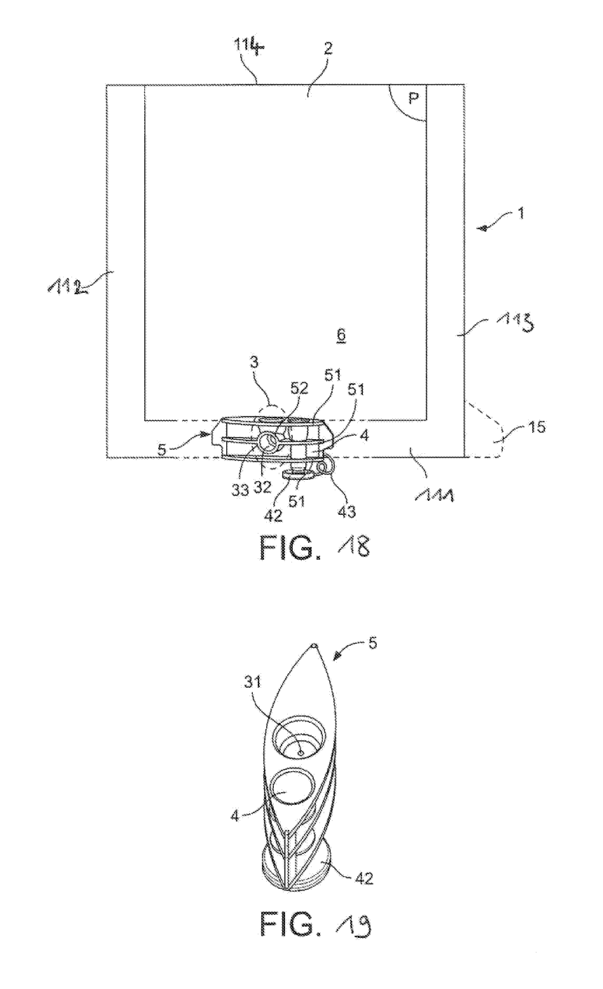

FIG. 18 illustrates a pack according one non-limiting embodiment of the presently disclosed and/or claimed inventive concept(s). In this illustration the bottom middle part of the inner volume 2 has been made transparent to make the insert 5 apparent. FIG. 19 is a top perspective view of the insert alone. In certain non-limiting embodiments, the pack is a planar sachet: it is oriented along a plane P essentially vertically oriented during beverage production. The pack is almost flat in the third perpendicular direction. The inner volume 2 is made of a flexible material sheet, said sheet being folded in its middle to form the top 114 of the pack. The sheet is bonded on its edges 112, 113, 111 to define the inner volume 2. The bottom bonded edge 13 includes the single insert 5: the fins 51 and the raising edge 52 around the water inlet 3 on the lateral sides of the insert improves the adhesion with the flexible material sheet during sealing. The sheet can comprise an excrescence 15 for improving manipulation of the pack.

In certain non-limiting embodiments, the insert 5 is a single piece of material (such as but not limited to) of plastic. It includes simultaneously a water inlet 3 for introducing water in the inner volume and a beverage outlet for dispensing the beverage or food issued from the mixing of the food or beverage ingredient with water.

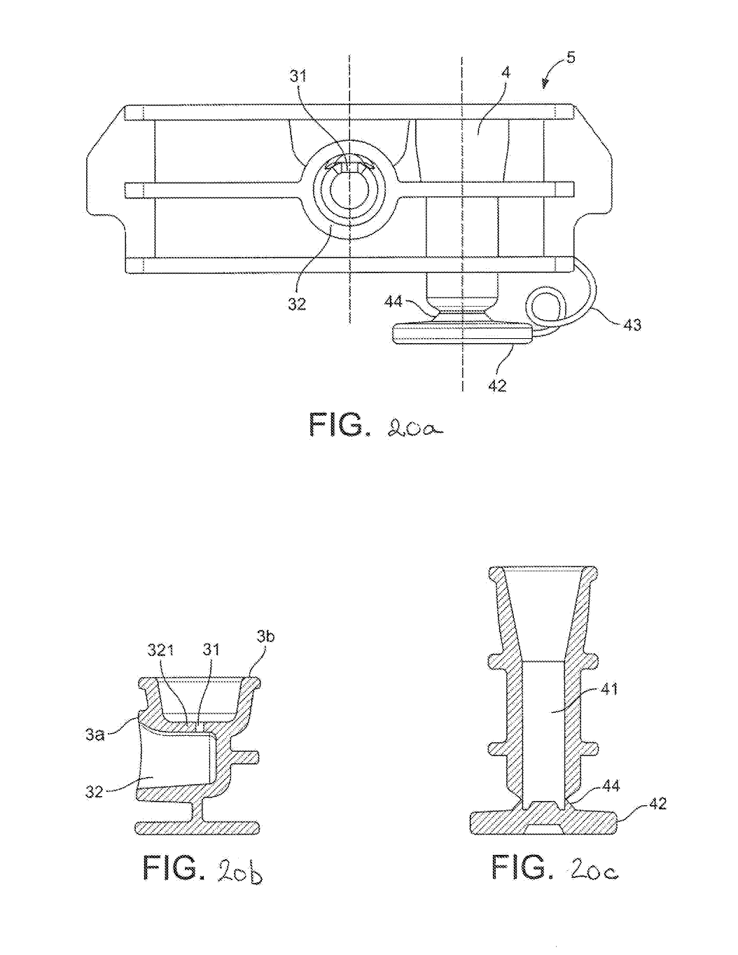

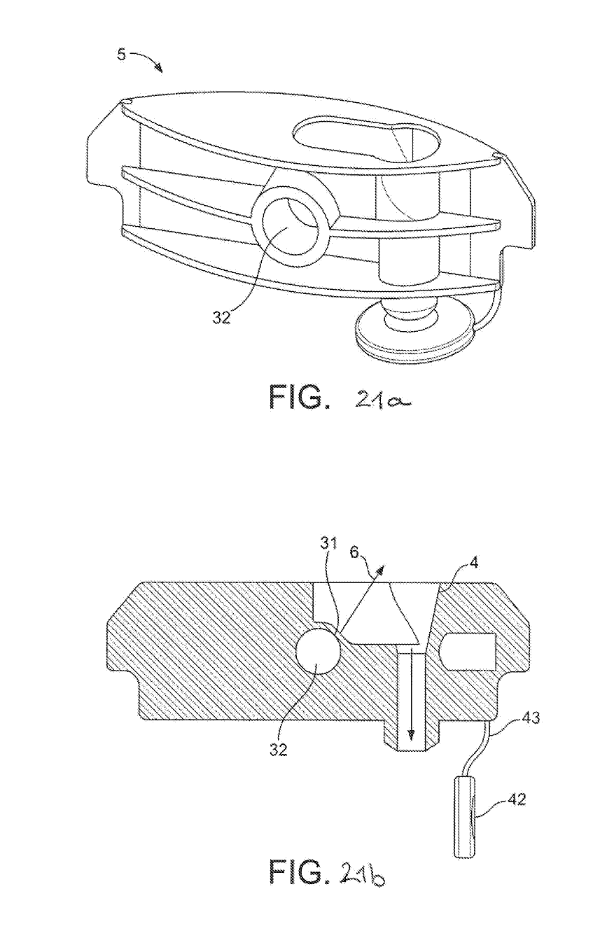

FIG. 20a is a magnified view of the insert and FIGS. 20b and 20c are respective sectional views of the insert through water inlet and beverage outlet detailing the internal shapes of these fluid channels in the insert. The beverage outlet is a vertical hole pierced in the insert. In certain non-limiting embodiments, it presents a diameter for dispensing the beverage under free flow. The diameter is (for example but not by way of limitation) above 2 mm for a circular section. The beverage outlet is closed at its external end by a plug 42. This plug is made of one piece with the rest of the insert. During beverage production this plug is cut or torn for opening the beverage outlet. The insert comprises also a plastic bond 43 for maintaining the plug attached to the pack after the opening of the beverage outlet. Consequently it is avoided that the plug falls in the beverage during its production. The beverage outlet also presents a weakening narrow zone 44 near the plug 42 so that said plug can be made easy to cut or tear off the plug with the beverage machine.

The water inlet 3 presents at its external end 3a an inlet chamber 32. This chamber is a hollow cavity; it is globally horizontally oriented. Its dimensions are configured for receiving the hollow needle of a beverage preparation machine in order to inject water. The inlet chamber 32 presents an evacuation end in its upper lateral wall 321: this evacuation end corresponds to an injection hole from which water can be injected in the inner volume 2 under the form of jet. The hole is circular and presents a diameter of at most 0.6 mm. Due to the configuration of the water inlet the water can be injected essentially horizontally in the inlet chamber 32 and essentially vertically in the inner volume 2 of the pack.

This embodiment of the presently disclosed and/or claimed inventive concept(s) presents the advantage of providing packs with inlet and outlet that are not in the vicinity of each other. Actually according to this embodiment the inlet and the outlet are on different sides of the pack: the beverage outlet external end is below the bottom of the pack whereas the water inlet external end is at the lateral side of the pack. Such a configuration particularly avoids contamination of the means for injecting water by the beverage flowing out of the beverage outlet. Besides a beverage preparation machine providing simultaneously a water injector and a dispensing area at the bottom of the pack receiving area is more difficult to conceive and does not enable an optimisation of the different elements of the machine.

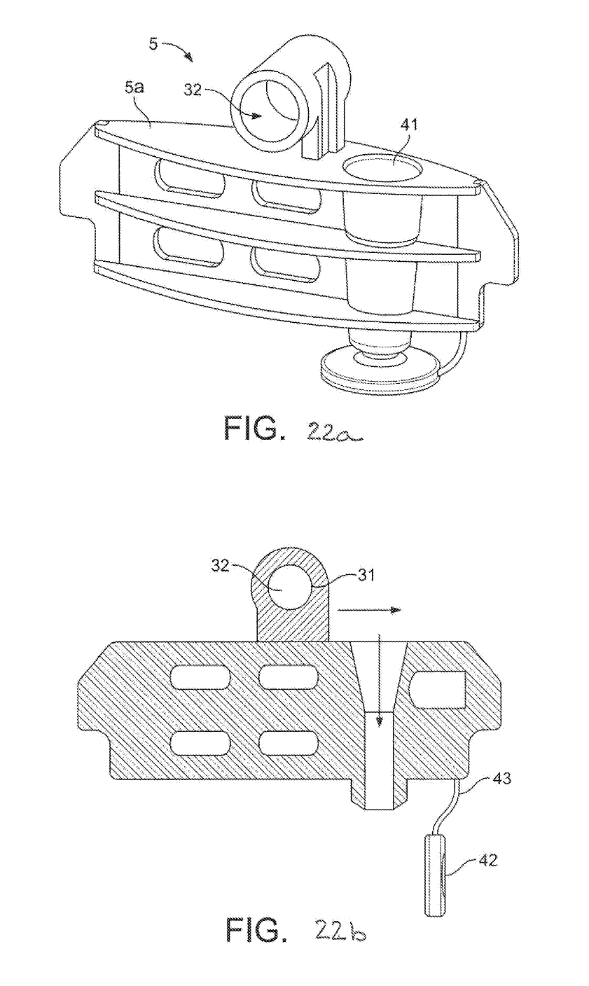

FIGS. 21a and 21b illustrate a variant of the single insert of FIG. 18. The beverage outlet presents the same feature as in the inert of FIG. 18. The water inlet presents an inlet chamber 32 that is globally horizontally oriented. The inlet chamber 32 presents an evacuation end in its lateral wall: this evacuation end corresponds to an injection hole 31 from which water can be injected in the inner volume 2 under the form of jet. In this variant the injection hole 31 is positioned in the lateral wall of the inlet chamber so as to create a jet of water 6 that presents an angle of about 45° with vertical and that is oriented in direction of the beverage outlet 4 (other orientation of the angle varying between −90° and 90° with vertical can be implemented). As illustrated in FIG. 21b during the beverage preparation the plug 42 at the end of the beverage outlet is removed so as to create an opening of the beverage outlet 4. During injection of water though the water inlet the orientation of the jet 6 of water enables the agitation of the liquid above the beverage outlet opening which has for consequences that a part of the beverage above the outlet is carried away and circulated again inside the inner volume which improves dissolution and eventually foaming. It also enables the agitation of the part of the beverage that flows through the beverage outlet 4; then the properties of the beverage in terms of frothing are maintained until the beverage emerges from the outlet. The qualities of the beverage in the drinking cup are optimised since the beverage has no time to quietly settle in the inner volume.

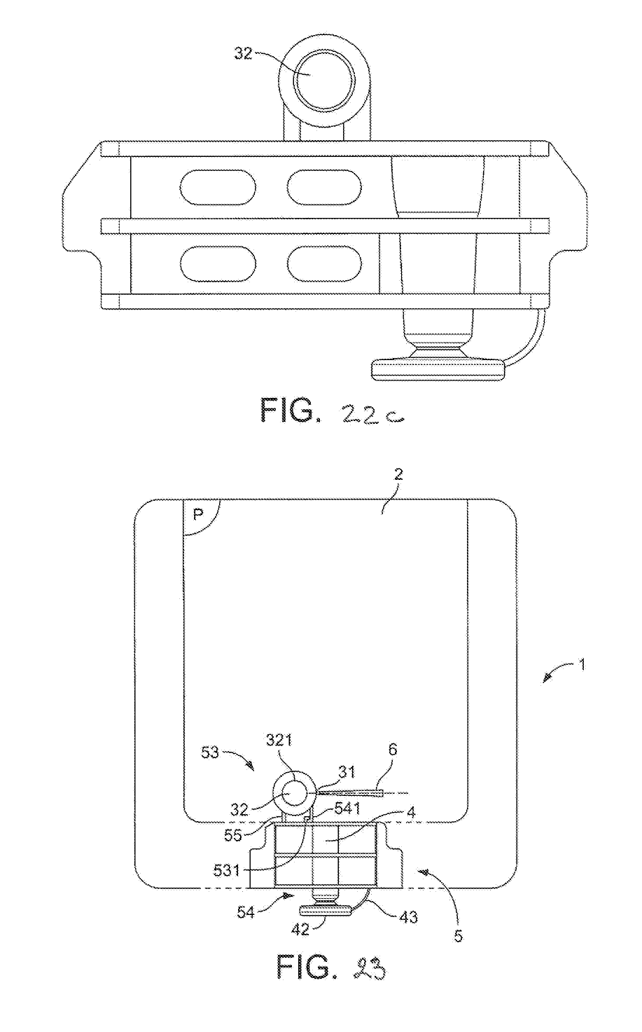

FIGS. 22a, 22b and 22c illustrate another variant of the single insert of FIG. 18. The beverage outlet presents the same feature as in the inert of FIG. 18. The water inlet presents an inlet chamber 32 that is globally horizontally oriented. The inlet chamber 32 presents the simple shape of a cylinder that is attached at the upper part 5a of the single insert. As illustrated in FIG. 22c this cylinder is opened at its both ends, which enables the introduction of a water needle either on one side or the other. The inlet chamber 32 presents an evacuation end in its lateral wall: this evacuation end corresponds to an injection hole 31 from which water can be injected in the inner volume 2 under the form of jet. In this variant the injection hole 31 is positioned in the lateral wall of the inlet chamber so as to create a jet of water 6 that is globally horizontal and that is oriented in direction of the beverage outlet 4. As illustrated in FIG. 22b during the beverage preparation the plug 42 at the end of the beverage outlet is removed so as to create an opening of the beverage outlet 4. During injection of water though the water inlet the orientation of the jet 6 of water enables the agitation of the liquid above the beverage outlet opening which has the same consequences as described hereabove for the single insert of FIGS. 21a and 21b.

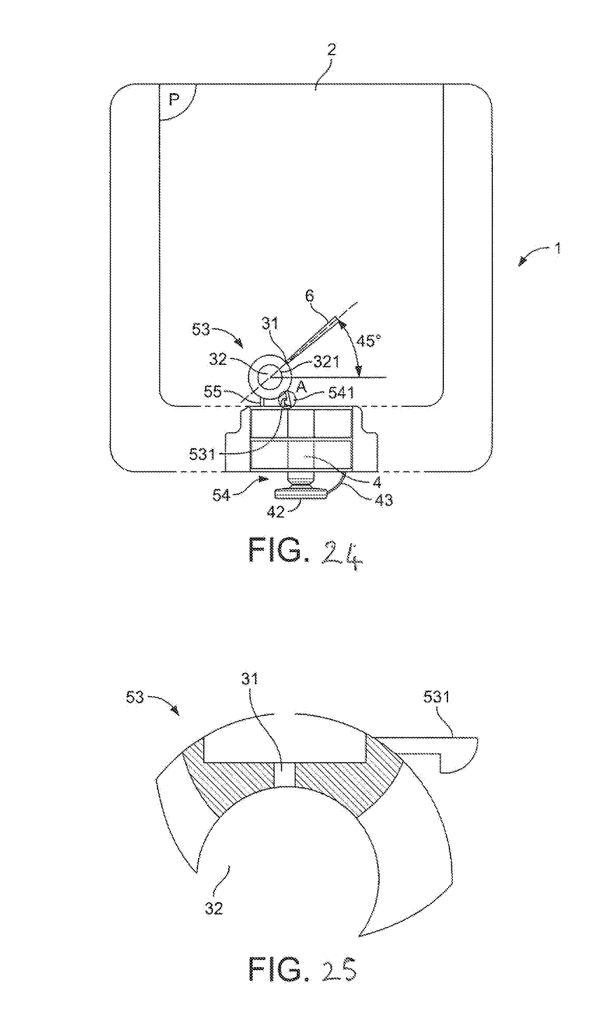

FIGS. 23 and 24 illustrate a range of packs according to the presently disclosed and/or claimed inventive concept(s). In these illustrations the bottom middle parts of the inner volumes 2 have been made transparent to make the inserts 5 apparent. In certain non-limiting embodiments, the packs are planar packs and present the same features as the pack of FIG. 18 except the insert. In both FIGS. 23 and 24 the insert 5 is a single piece of material (such as but not limited to, of plastic). It includes simultaneously a water inlet for introducing water in the inner volume and a beverage outlet for dispensing the beverage or food issued from the mixing of the food or beverage ingredient with water. In both cases the single insert 5 is made of two parts 53, 54 attached together by a hinge 55 and by hooks 531, 541 that hang on together. The first part 54 comprises the beverage outlet 4. This beverage outlet presents the same features as the beverage outlet of FIG. 18. The second part 53 comprises the water inlet. The water inlet comprises an inlet chamber 32 that is globally horizontally oriented. The inlet chamber 32 presents an evacuation end in its lateral wall 321: this evacuation end corresponds to the injection hole 31 from which water can be injected in the inner volume 2 under the form of jet 6. In certain non-limiting embodiments, the hole 31 is circular and presents a diameter comprised between 0.2 and 0.8 mm, such as but not limited to between 0.3 and 0.5 mm or about 0.4 mm.

FIG. 25 is a partial section view of the second part 53 around the injection hole 31 and illustrating the fact that said is hole is pierced in the lateral wall of the inlet chamber 32. FIG. 25 applies to the insert of FIG. 23 or 24. In the configuration of FIG. 23 the second part 53 is positioned so that the injection hole 31 essentially horizontally injects the jet of water 6 in the inner volume 2 of the pack. In the configuration of FIG. 24 the second part 53 is positioned so that the injection hole 31 injects the jet of water 6 in the inner volume 2 of the pack according to an angle of 45° with horizontal.

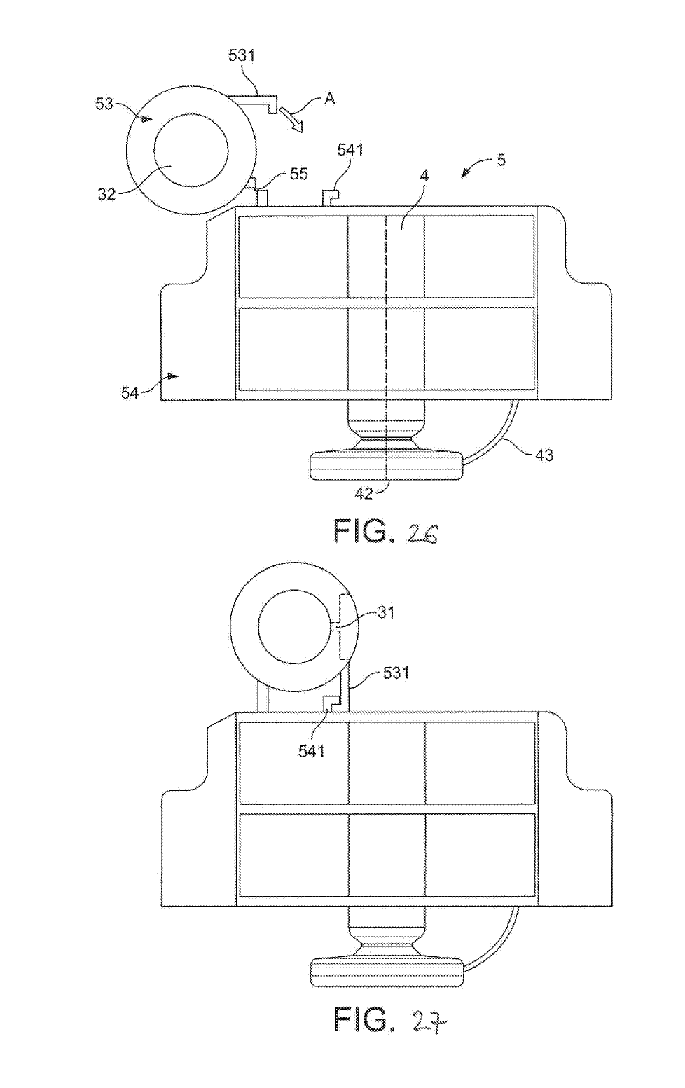

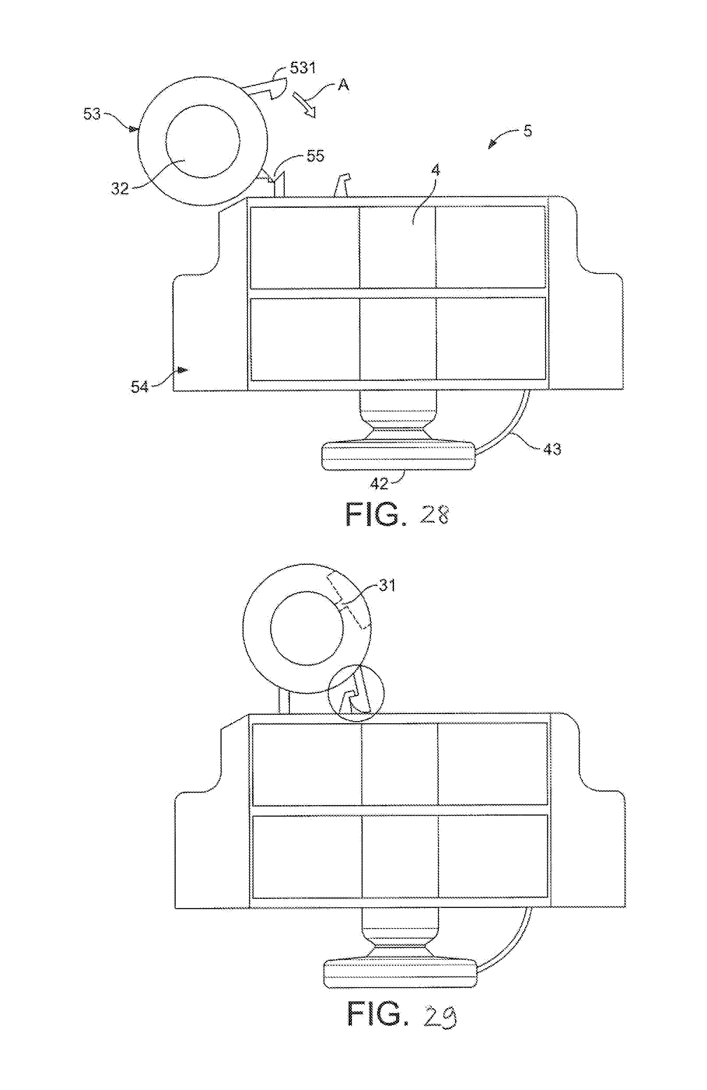

FIGS. 26 and 27 describe the insert 5 of FIG. 23 before its insertion in the pack. FIG. 26 illustrates the insert such as directly obtained from manufacturing, such as (but not limited to) by plastic injection moulding. Directly after manufacturing the first and second parts 53, 54 are only attached one to the other by a hinge 55. This hinge is made sufficiently thin so as to be folded. The first part 54 presents at its top a fastener 541 and the second part 53 presents on its lateral side a fastener 531. These both fasteners present the shape of hooks and are designed so that when the second part is moved near to the first part 54 by closing the hinge 55 (as illustrated by the arrow A in FIG. 26) then they hang on together and the hooks maintain the first part 54 and the second part 53 in a fixed position which is illustrated in FIG. 27. Once the hooks are hanged on together the insert 5 can be used for manufacturing the pack of FIG. 23. The hooks are also designed so as to define the orientation of the injection hole 31 and consequently the orientation of the jet 6 in the inner volume 2 of the pack. This orientation can particularly be varied according to the length of one of the hooks, for example the hook 541 of the first part 54 in the illustration of FIGS. 23 and 26. The shapes of the hooks 531, 541 can also be adapted to the particular relative orientation of the two parts one to the other.

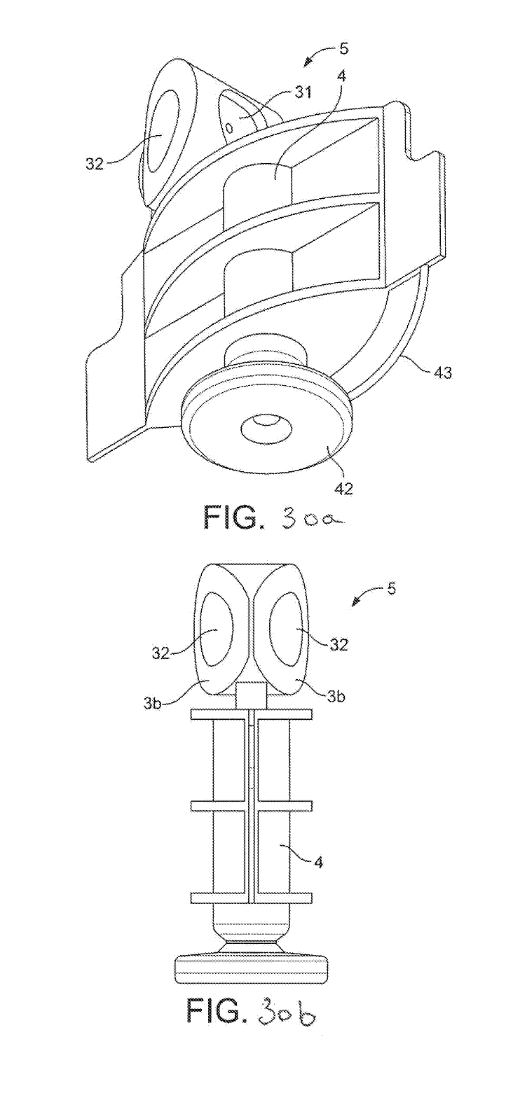

In the same manner as FIGS. 26 and 27, FIGS. 28 and 29 describe the insert 5 of FIG. 24 before its insertion in the pack. In the insert 5 of FIGS. 28 and 29 the hook 541 of the first part is longer than the corresponding hook of the insert of FIGS. 26 and 27. Consequently the second part 531 does not have to be turned around the hinge 55 as long as for the insert of FIGS. 26 and 27 for hanging on the hook 541 of the first part. As a consequence the injection hole 31 of FIGS. 28 and 29 can present a different orientation from the injection 31 of FIGS. 26 and 27.

This particular embodiment enables the production of a range of different packs adapted for the agitation and dissolution of different types of beverage or food ingredients.

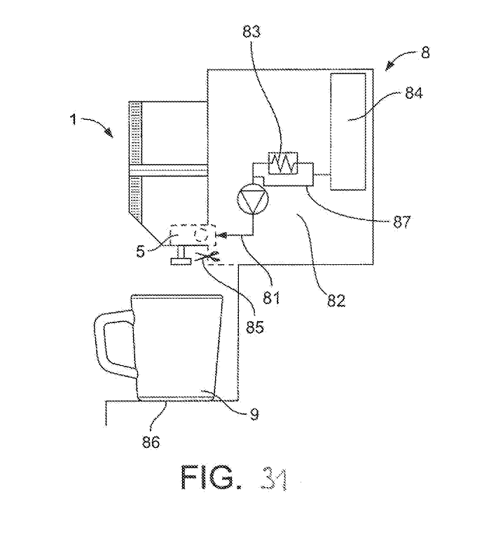

FIGS. 30a and 30b are respectively perspective and side views of an insert 5 that can be enclosed in a pack according to the presently disclosed and/or claimed inventive concept(s). The insert comprises one beverage outlet 4 and two water inlet chambers 32 placed symmetrically around the beverage outlet. Both of the water inlet chambers 32 are connected to the same injection 31. Depending on the sense of introduction of the pack in the beverage preparation machine either one or the other of the water inlet chambers 32 can be connected to the water supply. As the external ends 3b of the both water inlet chambers 32 are usually both closed before the use of the pack—e.g. covered by the sheet the pack is made of—the water needle of the beverage machine can pierce said sheet at one of the water inlet chambers 32 and remain the other water inlet chamber 32 closed.

FIG. 31 illustrates the interaction of a pack according to the presently disclosed and/or claimed inventive concept(s) with a beverage preparation machine 8. The machine comprises the same components as the machine of FIG. 9 and a cutter 85 for cutting the plug of the beverage outlet of the pack 1 when the pack presents a plug at the beverage outlet as illustrated for example in FIGS. 17 and 18.

The cutter 85 can be positioned so that the plug of the beverage outlet is automatically cut when the pack is introduced in the machine or when the beverage preparation is activated.

The presently disclosed and/or claimed inventive concept(s) presents the advantage of proposing packs for the preparation of food or beverages wherein a broad range of different foods and beverages can be produced with the same machine. The foods and beverages can differ by their natures (coffee, tea, chocolate, soup, . . . ), by their aspects (presence of crema for coffee, of foam for milk and chocolate, absence of bubbles for tea, . . . ), by their volumes (from espresso volume up to soup volume) and be obtained by the same machine. The machine elements can remain very simple and limited to a simple water needle.

The presently disclosed and/or claimed inventive concept(s) presents the advantage of proposing a consumer friendly preparation of foods and beverages. The beverage of food delivered from the pack is ready to be served and does not require an additional process step, for example for foaming the beverage.

The presently disclosed and/or claimed inventive concept(s) presents the advantage of proposing packs wherein the ingredients are fully protected from atmosphere before use.

The presently disclosed and/or claimed inventive concept(s) presents the advantage of proposing packs or preparing beverages wherein the contact of ingredients and prepared beverage with the machine is avoided and the risk of cross contamination is limited. The prepared beverages present optimal organoleptic properties.

The presently disclosed and/or claimed inventive concept(s) presents the advantage of proposing packs presenting a low environmental impact since it can be made of a laminated pouch with a small insert piece of plastic.

The presently disclosed and/or claimed inventive concept(s) presents the advantage of proposing packs of global similar shapes but with particular internal difference in order to deal with the preparation of various beverages from various food or beverage ingredients presenting different properties like: difference of dissolution, ability to clog, difference of volume,

This is one key element of temper evidence proof allowing the consumer to detect if the sachet has been tempered before.

The presently disclosed and/or claimed inventive concept(s) presents the advantage of proposing packs which can be very easily produced starting from flexible sheets and one single insert, for the simplest embodiment. In particular the pack usually does not comprise an internal filter or membrane to be positioned in the inner volume during manufacturing.

1. A pack with an inner volume in which a food or beverage ingredient is stored and in which a beverage is produced when water is introduced inside, said pack comprising:
at least one inlet configured for supplying water in the inner volume of the pack,
at least one outlet for dispensing a beverage from the inner volume of the pack, and
wherein the inlet and the outlet are positioned next to a bottom of the pack.

2. A The pack according to claim 1, further defined as comprising two flexible water impermeable sheets joined to one another to define the inner volume.

3. The pack according to claim 1, wherein the beverage outlet delivers the beverage as a free flow.

4. The pack according to claim 1, wherein the beverage outlet is an opening presenting a transverse section with a surface area equivalent to the surface of a circular surface of diameter of at least 1 mm.

5. The pack according to claim 1, wherein the beverage outlet is a straight tube oriented essentially vertically at the bottom of the pack.

6. The pack according to claim 1, wherein the food or beverage ingredient is a soluble food or beverage ingredient.

7. The pack according to claim 1, wherein the water inlet is configured for introducing water under the form of a jet in the inner volume of the pack.

8. The pack according to claim 1, wherein the water inlet is configured for introducing a water jet in the inner volume of the pack, said water jet presenting a velocity of at least about 20 m/s.

9. The pack according to any one of the precedent claims claim 1, wherein the water inlet is configured for transforming the pressurized water introduced by a beverage machine in the pack in a high velocity water jet in the inner volume of the pack.

10. The pack according to claim 1, wherein the water inlet comprises a hole presenting a transverse section with a surface area equivalent to the surface of a circular surface of diameter of at most 1 mm.

11. The pack according to claim 1, wherein the water inlet comprises a hole presenting a transverse section with a surface area equivalent to the surface of a circular surface of diameter comprised between 0.3 and 0.5 mm.

12. The pack according to claim 1, wherein the water inlet comprises a hole presenting a transverse section with a surface area equivalent to the surface of a circular surface of diameter comprised between 0.5 and 1.5 mm.

13. The pack according to claim 7, wherein the pack presents a plane shape oriented along a plane essentially vertically oriented during beverage production and the water inlet orientates the jet of water in a direction comprised in said plane.

14. The pack according to claim 7, wherein the water inlet is configured for orienting the water jet in direction of the beverage outlet.

15. The pack according to any one of the precedent claims claim 1, wherein said pack comprises one single insert including the water inlet and the beverage outlet, said single insert being positioned at the bottom of the pack, optionally the single insert of the pack presenting a shape for cooperating with the pack receiving area of a beverage production machine.

16. The pack according to claim 15, wherein it presents a generally plane shape, said plane shape presenting a face essentially vertically oriented during beverage production and the single insert being positioned at or next to the middle of the bottom of said face.

17. The pack according to claim 15, wherein the pack presents a generally plane shape, said plane shape presenting a face essentially vertically oriented during beverage production and the single insert being positioned at or next to a bottom corner of said face.

18. The pack according to claim 1, wherein the beverage outlet is closed by manufacturing and is configured for being opened at beverage production step, optionally the beverage outlet is closed by a plug, said plug comprising means for maintaining it attached to the pack after the opening of the beverage outlet, and wherein:
the means for maintaining the plug attached to the pack is a plastic bond attached to the single insert, and/or
the beverage outlet presents a weakening zone near the plug, and/or
the plug is part of one single insert including the water inlet and the beverage outlet.

19. The pack according to claim 1, wherein the water inlet is positioned in the pack so that it is almost totally essentially vertically oriented during beverage production.

20. A The pack according to claim 1, wherein the water inlet is positioned in the pack so that it is at least partially essentially horizontally oriented during beverage production, wherein the water inlet is configured so that the direction of the water flow in the external end (3a) of the water inlet is almost perpendicular to the direction of the water flow in the internal end (3b) of the water inlet.

21. The pack according to claim 1, further comprising two flexible water impermeable sheets joined to one another to define the inner volume and wherein the pack comprises one insert including at least one water inlet and wherein the water inlet is enclosed in the pack by the sheets defining the inner volume, optionally:
the pack is a plane pack made of one material sheet, said sheet being folded at the top of the pack so as to form two joined sheets, said sheets being bonded on their edges to define the inner volume, the bottom bonded edges including the insert, and/or
the external end of the water inlet is closed by the sheet bottom bonded edges.

22. A range of packs according to claim 1, wherein the packs differ by the size of the inner volume and/or the internal dimensions of the beverage outlet and/or the internal dimensions of the water inlet and/or the position of the water inlet and/or the position of the beverage outlet.

23. A method for the preparation of a food or beverage comprising the steps of:
positioning a pack according to claim 1 with the inlet and the outlet positioned downwardly,
injecting water into the pack to mix with the food or beverage ingredient,
allowing the prepared beverage to escape through the outlet into a receptacle.

24. A machine for preparing a beverage from a pack according to claim 1, said pack comprising a beverage outlet closed by a plug, said machine comprising at least:
a water supply,
a pump for pumping water from the water supply,
a water needle for injecting water in the water inlet of the pack, and
a device for cutting or tearing the plug of the beverage outlet of the pack.

25. A method for manufacturing a pack according to claim 1, the pack comprising one single insert including the water inlet and the beverage outlet, wherein the method comprises the steps of:
folding a sheet of material and bonding the both lateral edges to form a pouch,
filling the pouch through the last opened edges with a food or beverage ingredient, and
positioning the single insert between the opened edges and bonding said edges.
